(19) United States
(12) Patent Application Publication
(10) Pub. No.: US 2026/0176142 A1
(43) Pub. Date: Jun. 25, 2026

(54) METHOD OF MANUFACTURING CARBON NANOTUBE SHEET, APPARATUS FOR MANUFACTURING CARBON NANOTUBE SHEET, AND CARBON NANOTUBE SHEET

(71) Applicant: SHINKO ELECTRIC INDUSTRIES CO., LTD., Nagano (JP)

(72) Inventor: Takuya KUROSAWA, Nagano (JP)

(21) Appl. No.: 19/423,233

(22) Filed: Dec. 17, 2025

(30) Foreign Application Priority Data
Dec. 24, 2024 (JP) 2024-227433

(51) Int. Cl. C01B 32/168; B82Y 40/00; C01B 32/162

(52) U.S. Cl. CPC C01B 32/168; C01B 32/162; B82Y 40/00; C01B 2202/08; C01B 2202/24; C01P 2004/13; C01P 2006/32

(57) ABSTRACT

A method of manufacturing a carbon nanotube sheet includes providing carbon nanotubes, advancing an elastic sheet having a first surface and a second surface opposite to the first surface in a first direction toward a direction changing member, bringing the first surface into contact with the direction changing member and looping the elastic sheet over the direction changing member so as to extend the second surface, advancing the elastic sheet from the direction changing member in a second direction different from the first direction so as to contract the second surface, causing upper ends of the carbon nanotubes to penetrate the second surface that is extended by being looped over the direction changing member, thereby providing temporal fixation therefor, and moving the carbon nanotubes in the second direction while the upper ends are penetrating the second surface.

### CROSS-REFERENCE TO RELATED APPLICATIONS

The present application is based on and claims priority to Japanese Patent Application No. 2024-227433 filed on Dec. 24, 2024, with the Japanese Patent Office, the entire contents of which are incorporated herein by reference.

### FIELD

The present disclosures relate to methods of manufacturing a carbon nanotube sheet, apparatuses for manufacturing a carbon nanotube sheet, and carbon nanotube sheets.

### BACKGROUND

Conventionally, in order to efficiently release heat generated from a semiconductor device, the semiconductor device is connected to a heat dissipating member through a thermally conductive sheet. A carbon nanotube sheet has been proposed as the thermally conductive sheet. The carbon nanotube sheet has the property that the higher the density of the carbon nanotube, the higher the heat dissipation efficiency.

The technology disclosed in Patent Document 1 enables the realization of the intended object, but a large device is required to spread a silicone rubber sheet with a strong force.

### Related-Art Document

### [Patent Document]

Patent Document 1: Japanese Patent No. 6283293
Patent Document 2: International Publication Pamphlet No. WO2016/182018
Patent Document 3: Japanese National Publication of International Patent Application No. 2018-524255

### SUMMARY

According to an aspect of the embodiment, a method of manufacturing a carbon nanotube sheet includes providing carbon nanotubes, advancing an elastic sheet having a first surface and a second surface opposite to the first surface in a first direction toward a direction changing member, bringing the first surface into contact with the direction changing member and looping the elastic sheet over the direction changing member so as to extend the second surface, advancing the elastic sheet from the direction changing member in a second direction different from the first direction so as to contract the second surface, causing upper ends of the carbon nanotubes to penetrate the second surface that is extended by being looped over the direction changing member, thereby providing temporal fixation therefor, and moving the carbon nanotubes in the second direction while the upper ends are penetrating the second surface.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIGS. 1A through 1D are drawings illustrating a method of manufacturing a carbon nanotube sheet according to an embodiment;

FIGS. 2A and 2B are drawings illustrating the method of manufacturing a carbon nanotube sheet according to an embodiment;

FIGS. 3A and 3B are drawings illustrating the method of manufacturing a carbon nanotube sheet according to an embodiment;

FIG. 4 is a drawing illustrating an apparatus for manufacturing a carbon nanotube sheet;

FIG. 5 is a drawing illustrating the apparatus for manufacturing a carbon nanotube sheet;

FIG. 6 is a drawing illustrating the apparatus for manufacturing a carbon nanotube sheet;

FIG. 7 is a drawing illustrating a method of temporarily fixing a carbon nanotube to an elastic sheet;

FIG. 8 is a drawing illustrating the method of temporarily fixing a carbon nanotube to an elastic sheet;

FIG. 9 is a drawing illustrating the method of temporarily fixing a carbon nanotube to an elastic sheet;

FIGS. 10A and 10B are cross-sectional views illustrating a method of manufacturing a semiconductor apparatus;

FIG. 11 is a cross-sectional view illustrating the method of manufacturing a semiconductor apparatus; and

FIG. 12 is a cross-sectional view illustrating the method of manufacturing a semiconductor apparatus.

### DESCRIPTION OF EMBODIMENTS

In the following, embodiments will be specifically described with reference to the accompanying drawings. In the specification and the drawings, components having substantially the same functional configuration may be referred to by the same reference numeral, and a duplicate description thereof may be omitted. In the present disclosure, the X-axis, the Y-axis, and the Z-axis are mutually orthogonal. A plane including the X-axis and the Y-axis is referred to as an XY plane, a plane including the Y-axis and the Z-axis is referred to as a YZ plane, and a plane including the Z-axis and the X-axis is referred to as a ZX plane. For convenience, the positive Z side is referred to as the upper side, and the negative Z side is referred to as the lower side. Further, the “plan view” refers to a view of an object as seen from the positive Z direction, and the “plan shape” refers to the shape of an object as seen from the positive Z direction. It may be noted, however, that a carbon nanotube sheet or the like may be placed upside down when used, or arranged at any angle.

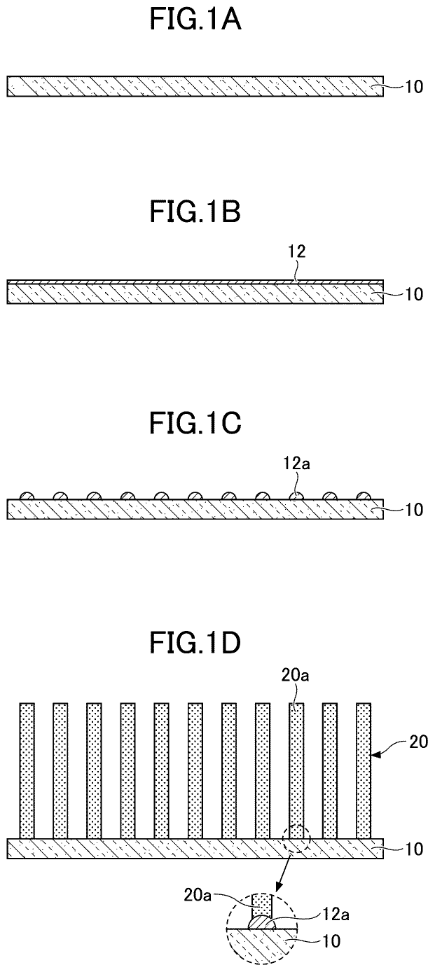

An embodiment of the present disclosure relates to a method of manufacturing a carbon nanotube sheet. FIGS. 1A to 1D, FIGS. 2A and 2B, and FIGS. 3A and 3B are drawings illustrating a method of manufacturing a carbon nanotube sheet according to an embodiment.

In the method of manufacturing a carbon nanotube sheet according to the embodiment, first, a silicon substrate 10 is prepared as illustrated in FIG. 1A. The silicon substrate 10 is used as a base for forming carbon nanotubes. An insulating layer such as a silicon oxide layer may optionally be formed on each surface of the silicon substrate 10.

A plurality of carbon nanotube-forming regions are defined on the silicon substrate 10, and one carbon nanotube-forming region is illustrated in FIG. 1A. Although the silicon substrate 10 is used here as an example of the substrate, a different type of substrate such as a ceramic substrate or a glass substrate may alternatively be used.

Next, as illustrated in FIG. 1B, an iron (Fe) film having a thickness of about 2.5 nm is formed as a catalyst metal film 12 on the entire upper surface of the silicon substrate 10 by sputtering or the like. The catalyst metal film 12 is formed as a catalyst for forming carbon nanotubes by chemical vapor deposition (CVD). The material of the catalyst metal film 12 may be cobalt (Co), nickel (Ni), gold (Au), silver (Ag), or platinum (Pt), instead of iron.

Then, as illustrated in FIG. 1C, the silicon substrate 10 is heat-treated at a temperature of 650° C. for 5 to 10 minutes. As a result, the catalyst metal film 12 decomposes into fine catalyst metal particles 12a.

As illustrated in FIG. 1D, a plurality of carbon nanotubes 20a are grown on the silicon substrate 10 by thermal CVD using the fine catalyst metal particles 12a as a catalyst. This arrangement effectively produces a carbon nanotube aggregate 20 that includes the plurality of carbon nanotubes 20a formed side by side in lateral directions. As described above, the method of manufacturing a carbon nanotube sheet includes a step of preparing the plurality of carbon nanotubes 20a.

As illustrated in a partially enlarged view in FIG. 1D, the carbon nanotubes 20a that grow on the fine catalyst metal particles 12a are formed so as to be oriented substantially perpendicular to the surface of the silicon substrate 10. Growth conditions for the carbon nanotubes 20a by the thermal CVD include, for example, the use of a mixed gas of acetylene and argon with a partial pressure ratio of 1:9 as a raw material gas, a total gas pressure of 1 kPa in the film formation chamber, a temperature of 650° C., and a growth time of 30 minutes. The height of the carbon nanotubes 20a is, for example, in the range of approximately 100 μm to 300 μm. With the use of the above-noted conditions for the formation of the carbon nanotubes 20a, the density ρ1 of the carbon nanotubes 20a per unit area on the silicon substrate 10 is in the range of approximately 2% to 3%.

Subsequently, the carbon nanotubes 20a are temporarily fixed to an elastic sheet while the density thereof is increased. The elastic sheet is, for example, a rubber sheet such as a silicone rubber sheet.

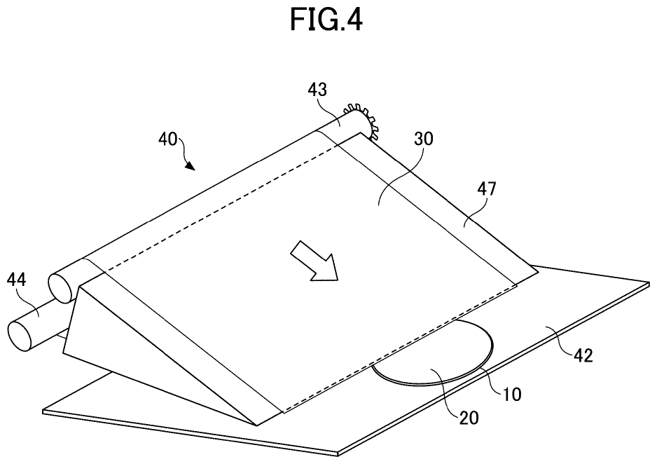

An apparatus for manufacturing a carbon nanotube sheet capable of temporarily fixing the carbon nanotubes 20a to an elastic sheet will now be described. FIGS. 4 to 6 are drawings illustrating an apparatus for manufacturing a carbon nanotube sheet.

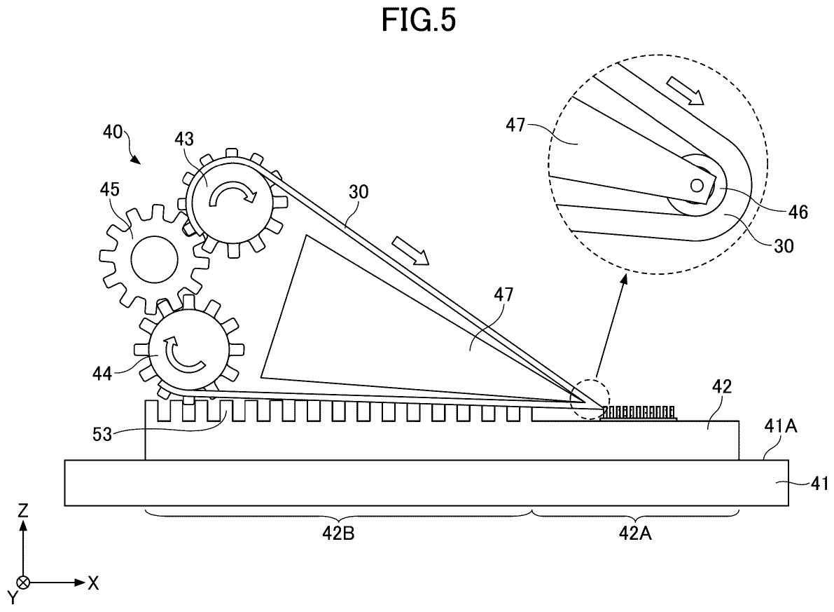

As illustrated in FIGS. 4 and 5, a carbon nanotube sheet manufacturing apparatus 40 includes a support base 41, a stage 42 with a flat gear, an unwinding roller 43 with a gear, a winding roller 44 with a gear, a drive gear 45, a direction changing roller 46, and a support member 47.

The support base 41 has a flat upper surface 41A, and the stage 42 is mounted on the support base 41 movably along the X-axis parallel to the upper surface 41A. The stage 42 includes a region 42A and a region 42B. In the region 42A, the upper surface is flat, and in the region 42B, a flat gear 53 is formed on the upper surface. The teeth of the flat gear 53 extend parallel to the Y-axis, which is parallel to the upper surface 41A and perpendicular to the X-axis.

The unwinding roller 43, the winding roller 44, the drive gear 45, and the direction changing roller 46 each have a rotation axis parallel to the Y-axis. The teeth of the drive gear 45 are engaged with the teeth of the unwinding roller 43 and the teeth of the winding roller 44. The gear ratio between the drive gear 45 and the unwinding roller 43 may or may not be 1. The gear ratio between the drive gear 45 and the winding roller 44 may or may not be 1. The teeth of the winding roller 44 are also engaged with the teeth of the flat gear 53. The rotation of the drive gear 45 causes the rotation of the unwinding roller 43 and the winding roller 44, and the stage 42 moves parallel to the X-axis with the rotation of the winding roller 44. An elastic sheet 30, to which the aggregate 20 is to be temporarily fixed, is provided as a roll wound around the unwinding roller 43, and the elastic sheet 30 is wound by the winding roller 44 via the direction changing roller 46. At the time of winding the elastic sheet 30, the winding roller 44 rotates in the direction that causes the region 42A of the stage 42 to approach the winding roller 44 with the rotation of the winding roller 44.

The direction changing roller 46 is disposed apart from the unwinding roller 43, the winding roller 44, and the drive gear 45. The direction changing roller 46 has a plurality of ball bearings with the same diameter arranged coaxially along the Y-axis, for example. The direction changing roller 46 is spaced apart from the region 42A of the stage 42 by a distance slightly smaller than the sum of the thickness of the silicon substrate 10, the thickness of the aggregate 20, and the thickness of the elastic sheet 30. The support member 47 rotatably supports the direction changing roller 46. The direction changing roller 46 is an example of a direction changing member.

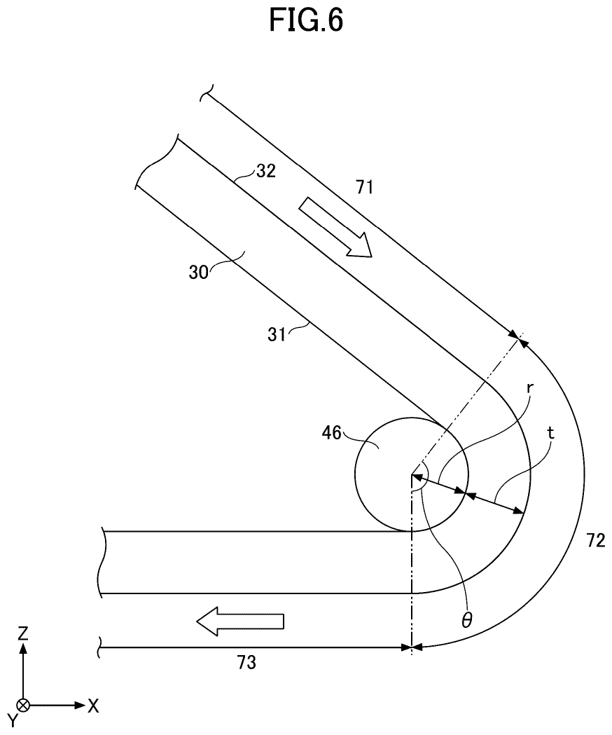

As illustrated in FIG. 6, the elastic sheet 30 runs over the direction changing roller 46. The movement path of the elastic sheet 30 includes a path 72 in contact with a portion of the direction changing roller 46 over an angular range of θ (°) in the circumferential direction, a path 71 closer to the unwinding roller 43 (upstream side) than the path 72, and a path 73 closer to the winding roller 44 (downstream side). In the path 71, the elastic sheet 30 advances in a first direction, and in the path 73, the elastic sheet 30 advances in a second direction different from the first direction. In the paths 71 and 73, the elastic sheet 30 are not in contact with the direction changing roller 46. The elastic sheet 30 has a surface 31 in contact with the direction changing roller 46 and a surface 32 opposite the surface 31. The size of a given area on the surface 31 is constant while moving through the paths 71, 72 and 73. In contrast, the size of the corresponding area on the surface 32 is equal to the size of the given area on the surface 31 in the paths 71 and 73, but is larger than the size of the given area on the surface 31 in the path 72. The surface 31 is an example of the first surface, and the surface 32 is an example of the second surface.

The following is a description of the change in the size of an area on the surface 32. The distance between the surface 31 and the surface 32, that is, the thickness of the elastic sheet 30, is denoted as t, and the radius of the direction changing roller 46 is denoted as r. With respect to the portion of the elastic sheet 30 lying over the path 72, the length (arc length) L1 of the surface 31 is “2πr×θ/360(°),” and the length (arc length) L2 of the surface 32 is “2π (r+t)×θ/360(°) ” in the ZX plane. As a result, the length L2 becomes “1+t/r” times the length L1 during the passage of the elastic sheet 30 through the path 72. In contrast, as described above, the size of a given area on the surface 32 is equal to the size of the corresponding area on the surface 31 in the paths 71 and 73. That is, in the ZX plane, the size of a given area on the surface 32 becomes “1+t/r” times as large during passage through the path 72 as during passage through the paths 71 and 73. For example, when the thickness t is 2 mm and the radius r is 1 mm, the size of a given area on the surface 32 in the ZX plane becomes 3 times as large during passage through the path 72 as during passage through the paths 71 and 73. Further, when the thickness t is 2 mm and the radius r is 0.5 mm, the size of a given area on the surface 32 in the ZX plane becomes 5 times as large during passage through the path 72 as during passage through the paths 71 and 73.

In order to temporarily fix the aggregate 20 to the elastic sheet 30 by using the carbon nanotube sheet manufacturing apparatus 40 as described above, the silicon substrate 10 is fixed on the stage 42, and the direction changing roller 46 and the support member 47 are aligned such that the upper end portion of the aggregate 20 penetrate the surface 32 of the elastic sheet 30 in the path 72. The drive gear 45 is then rotated so that the elastic sheet 30 is wound on the winding roller 44 while being unwound from the unwinding roller 43, and the stage 42 is moved to bring the region 42A closer to the winding roller 44. That is, the stage 42 is moved in the second direction. As described above, the method of manufacturing the carbon nanotube sheet includes a step of advancing the elastic sheet 30 in the first direction toward the direction changing roller 46, a step of extending the surface 32 by bringing the surface 31 into contact with the direction changing roller 46 and passing the elastic sheet 30 over the direction changing roller 46, and a step of contracting the surface 32 by advancing the elastic sheet 30 from the direction changing roller 46 in the second direction.

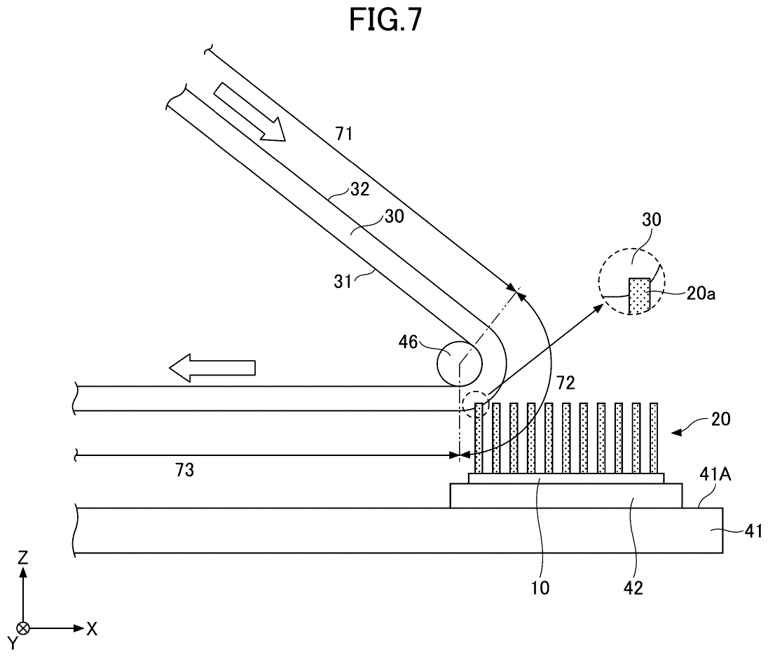

Pursuant to the noted arrangement, the aggregate 20 is temporarily fixed to the elastic sheet 30 as follows. FIGS. 7 to 9 illustrate a method of temporarily fixing the carbon nanotubes 20a to the elastic sheet 30.

First, as illustrated in FIG. 7, the upper ends of the carbon nanotubes 20a located near the negative X end of the aggregate 20 penetrate the surface 32 of the elastic sheet 30 in the path 72 (see also the partially enlarged view). At this time, the density of the carbon nanotubes 20a on the surface 32 remains the same as the density ρ1 observed immediately after growth.

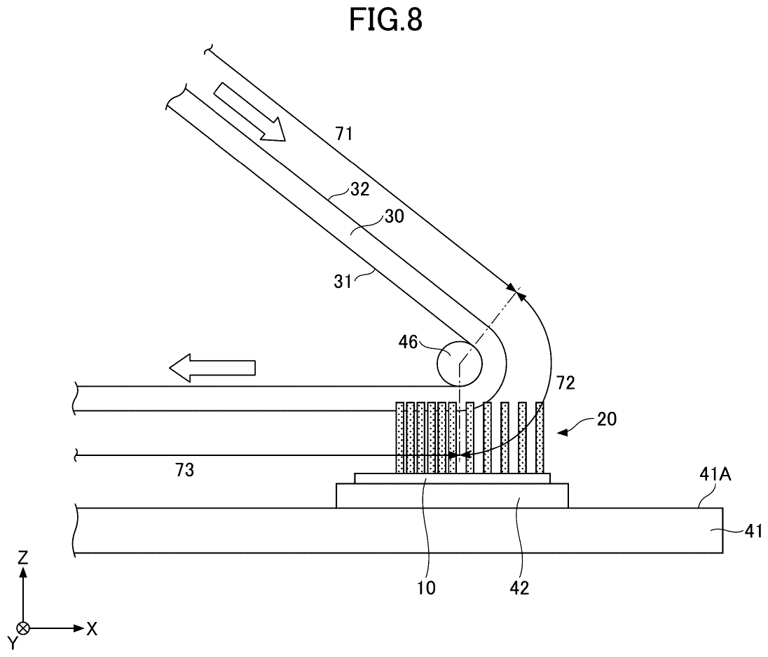

Thereafter, the rotation of the drive gear 45 causes the aggregate 20 to move in the second direction, with the portion of the surface 32 penetrated by the carbon nanotubes 20a, as illustrated in FIG. 8. As this happens, the surface 32 contracts in the ZX plane along the path 73, and the density of the carbon nanotubes 20a on the surface 32 becomes a density ρ2 higher than the density ρ1. For example, when the thickness t is 2 mm and the radius r is 1 mm, the density ρ2 becomes 3 times the density ρ1. With the thickness t being 2 mm and the radius r being 0.5 mm, the density ρ2 becomes 5 times the density ρ1. In the path 72, the upper ends of the carbon nanotubes 20a located in other portions of the aggregate 20 successively penetrate the surface 32 of the elastic sheet 30.

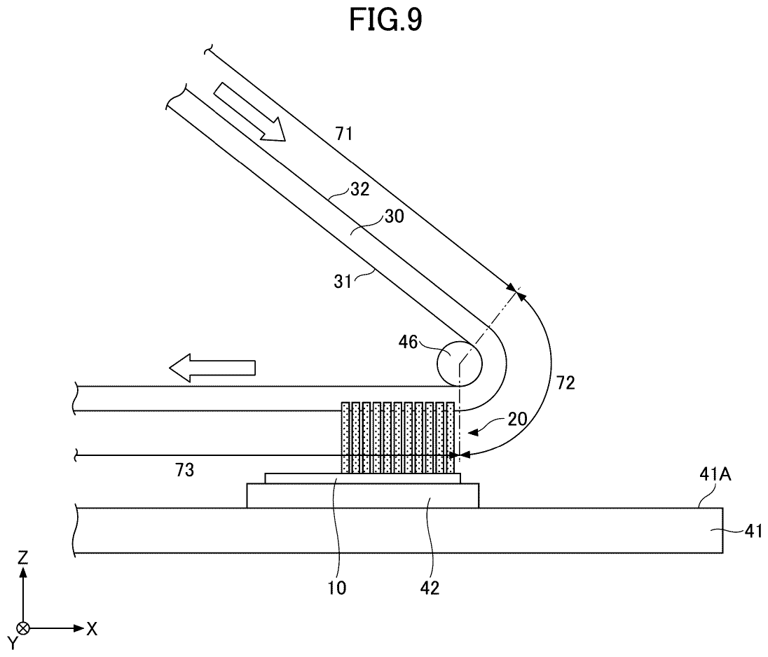

Subsequently, further rotation of the drive gear 45 causes the entire aggregate 20 moves to the path 73 as illustrated in FIG. 9, and the density of the carbon nanotubes 20a on the surface 32 becomes the density ρ2 for the entire aggregate 20. As described above, the method of manufacturing a carbon nanotube sheet includes a step of temporarily fixing the upper ends of the carbon nanotubes 20a piercing the surface 32 extended by being stretched over the direction changing roller 46, and a step of moving the carbon nanotubes 20a in the second direction with the upper ends piercing the surface 32.

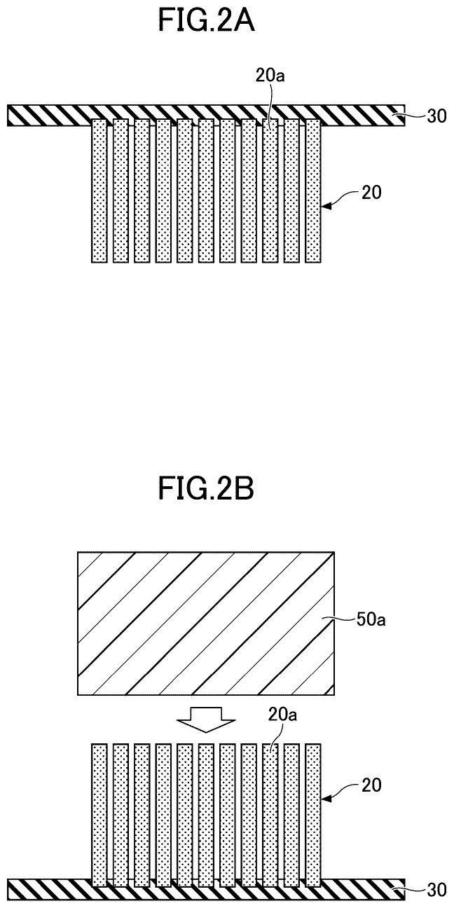

Following these steps enables the temporal fixation of the aggregate 20 on the elastic sheet 30 as illustrated in FIG. 2A. The carbon nanotubes 20a with their upper ends piercing the surface 32 are pulled along with the contraction of the surface 32 and detached from the silicon substrate 10. When some carbon nanotubes 20a are not detached from the silicon substrate 10, the aggregate 20 is detached from the silicon substrate 10 after the temporal fixation of the aggregate 20.

As illustrated in FIG. 2B, the structure illustrated in FIG. 2A is turned upside down. Further, a thermosetting resin sheet 50a is arranged over the aggregate 20. When the overall dimensions of the elastic sheet 30 are disproportionately large relative to the portion where the aggregate 20 is temporarily fixed, a part of the elastic sheet 30 including the portion where the aggregate 20 is temporarily fixed may be cut out.

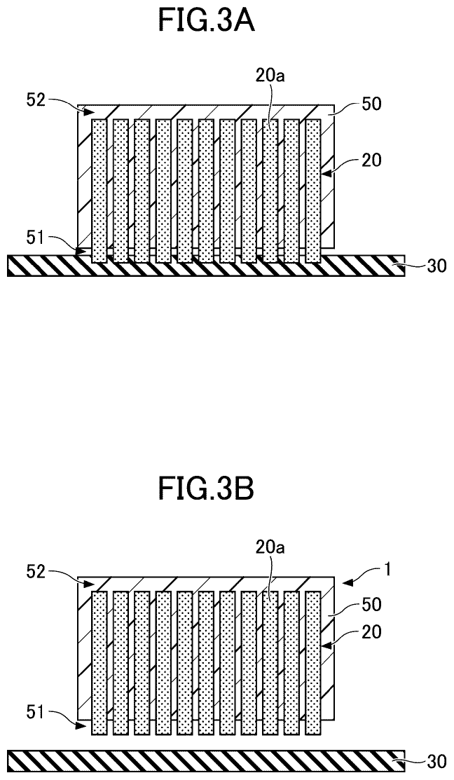

Next, while pressing the thermosetting resin sheet 50a downward with a pressing member (not illustrated), heat treatment is performed at a temperature of 200° C. for a treatment time of 1 minute. This softens the thermosetting resin sheet 50a arranged on the aggregate 20, causing the resin to flow into and permeate the gaps between the carbon nanotubes 20a as illustrated in FIG. 3A.

In this manner, the gaps between the carbon nanotubes 20a are impregnated with the thermosetting resin 50. By the use of the above-noted resin heating conditions, the thermosetting resin 50 is still in an uncured state at this stage. In this manner, the aggregate 20 is integrated with the thermosetting resin 50 to form a sheet. In so doing, the quantity of the impregnated thermosetting resin 50 is preferably adjusted such that the surrounding area of the proximal portions 51 of the carbon nanotubes 20a on the elastic sheet 30 becomes a void where the thermosetting resin 50 is nonexistent. This is because when the thermosetting resin 50 comes into contact with the elastic sheet 30, detaching the aggregate 20 from the elastic sheet 30 becomes difficult. The heights of the proximal portions 51 in the void are, for example, in the range of approximately 20 μm to 30 μm. In contrast, the distal ends 52 of the carbon nanotubes 20a are covered with the uncured thermosetting resin 50. Instead of the thermosetting resin 50, the aggregate 20 may similarly be impregnated with a thermoplastic resin. As described above, the method of manufacturing the carbon nanotube sheet includes a step of impregnating the gaps between the carbon nanotubes 20a with the thermosetting resin 50.

As illustrated in FIG. 3B, the aggregate 20 is detached from the elastic sheet 30. When this is done, the thermosetting resin 50 is not adhered to the elastic sheet 30 as described above, which facilitates the detachment of the aggregate 20 from the elastic sheet 30. As described above, the method of manufacturing a carbon nanotube sheet includes a step of detaching carbon nanotubes 20a from the elastic sheet 30.

By following these steps, the fabrication of the carbon nanotube sheet 1 is effectively achieved.

In the present embodiment, the upper ends of the carbon nanotubes 20a penetrate the portion of the surface 32 extended by the bending of the elastic sheet 30, thereby temporarily fixing the aggregate 20, followed by the contraction of the surface 32 to increase the density of the carbon nanotubes 20a. With this arrangement, a large apparatus is not required, and the small manufacturing apparatus 40 suffices to effectively increase the density of the carbon nanotubes 20a.

It may be noted that in the manufactured carbon nanotube sheet 1, the densities differ along the two directions orthogonal to each other.

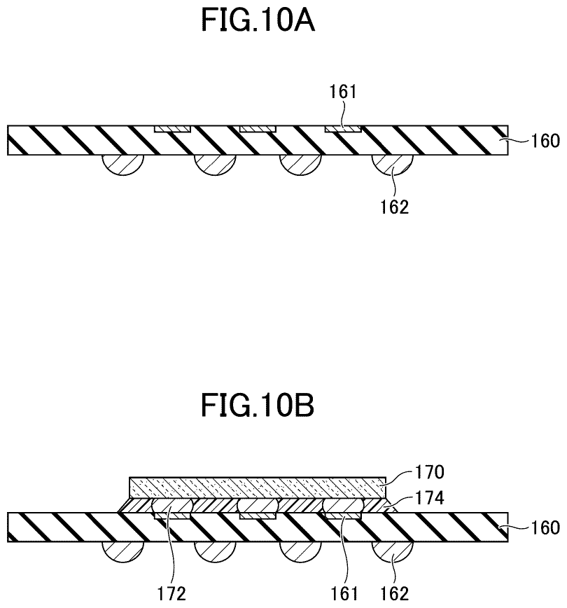

The following describes a method of manufacturing a semiconductor apparatus having the carbon nanotube sheet 1 as a thermally conductive sheet. FIGS. 10A and 10B through FIG. 12 are cross-sectional views illustrating a method of manufacturing a semiconductor apparatus.

First, as illustrated in FIG. 10A, an interconnect substrate 160 is prepared. The interconnect substrate 160 has connection pads 161 made of copper or the like embedded in the upper surface and external connection terminals 162 made of solder or the like on the lower surface. The connection pads 161 are electrically connected to the external connection terminals 162 through multilayer interconnects (not illustrated) formed inside the interconnect substrate 160.

As illustrated in FIG. 10B, a semiconductor device 170 having bump electrodes 172 on its lower surface is separately prepared. Then, the bump electrodes 172 of the semiconductor device 170 are connected to the connection pads 161 of the interconnect substrate 160 through solder (not illustrated). That is, the semiconductor device 170 is flip-chip connected to the interconnect substrate 160. Subsequently, the gap between the semiconductor device 170 and the interconnect substrate 160 is filled with an underfill resin 174. The semiconductor device 170 may be a central processing unit (CPU) or the like, which generates a large amount of heat during operation.

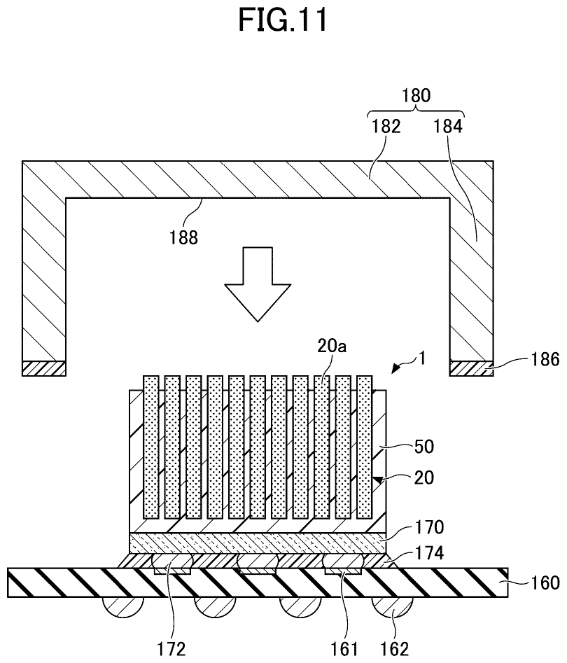

As illustrated in FIG. 11, the carbon nanotube sheet 1 is arranged on the upper surface of the semiconductor device 170. The carbon nanotube sheet 1 is arranged on the semiconductor device 170 such that the side of the sheet where the carbon nanotube aggregate 20 is covered with the thermosetting resin 50 faces downward.

Separately, a heat spreader 180 is prepared as a heat dissipation member. The heat spreader 180 includes a flat plate 182 and a frame-shaped projection 184 extending downward from the peripheral edge thereof, thereby defining a recess 188 in a central area on the lower side. Examples of the heat spreader 180 include an oxygen-free copper member with a nickel-plated outer surface. The projection 184 of the heat spreader 180 is placed on the periphery of the interconnect substrate 160 via a thermosetting adhesive 186.

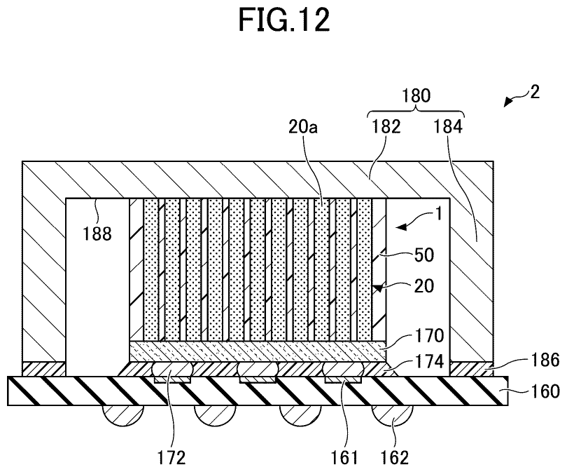

As illustrated in FIG. 12, while pressing the heat spreader 180 downward with a pressing member (not illustrated), heat treatment is performed under conditions of a temperature of 250° C. and a treatment time of 20 to 30 minutes. The depth of the recess 188 of the heat spreader 180 is adjusted so that the end surface of the recess 188 of the heat spreader 180 comes in contact with the upper end of each carbon nanotube 20a of the carbon nanotube sheet 1.

By the heat treatment while pressing, the uncured thermosetting resin 50 on the lower side of the carbon nanotube sheet 1 flows and is pushed aside laterally. As a result, the lower ends of the carbon nanotubes 20a of the carbon nanotube sheet 1 are brought into contact with the upper surface of the semiconductor device 170. Further, since the upper ends of the carbon nanotubes 20a of the carbon nanotube sheet 1 are originally exposed, they are brought into contact with the bottom surface of the recess 188 of the heat spreader 180.

The heat treatment completely cures the thermosetting resin 50 of the carbon nanotube sheet 1. The upper surface of the carbon nanotube sheet 1 and the end surface of the recess 188 of the heat spreader 180 are thus bonded by the thermosetting resin 50. Further, the lower surface of the carbon nanotube sheet 1 and the upper surface of the semiconductor device 170 are bonded by the thermosetting resin 50. Moreover, the projection 184 of the heat spreader 180 is bonded to the peripheral area of the interconnect substrate 160 by the thermosetting adhesive 186.

The above-described procedure enables the manufacture of the semiconductor apparatus 2.

As an alternative arrangement, the upper side of the carbon nanotube sheet 1 may first be pressed and bonded to the end surface of the recess 188 of the heat spreader 180, and, then, the lower side of the carbon nanotube sheet 1 may be bonded to the upper surface of the semiconductor device 170.

As illustrated in FIG. 12, in the semiconductor apparatus 2 is such that the semiconductor device 170 is flip-chip connected to the interconnect substrate 160. The underfill resin 174 fills the gap between the semiconductor device 170 and the interconnect substrate 160.

The frame-shaped projection 184 of the heat spreader 180 is bonded to the peripheral portion of the interconnect substrate 160 by the adhesive 186. The semiconductor device 170 is accommodated in the recess 188 of the heat spreader 180. The carbon nanotube sheet 1 is disposed as a thermally conductive sheet between the upper surface of the semiconductor device 170 and the end surface of the recess 188 of the heat spreader 180. The lower end of each carbon nanotube 20a of the carbon nanotube sheet 1 is in contact with the upper surface of the semiconductor device 170. The upper end of each carbon nanotube 20a of the carbon nanotube sheet 1 is in contact with the end surface of the recess 188 of the heat spreader 180.

A heat sink may be provided on the heat spreader 180 via a thermal interface material (TIM). The heat sink has, for example, a flat plate and a number of heat dissipating fins projecting therefrom. Alternatively, a heat pipe may be disposed on the heat spreader 180 of the semiconductor apparatus 2 via a thermal interface material. The heat pipe transfers and dissipates heat through a phase change involving evaporation and condensation of a working liquid enclosed in the sealed pipe, for example.

According to at least one embodiment, the density of carbon nanotubes is effectively improved with a small device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

The disclosures herein non-exhaustively include the subject matter set forth in the following clause.

[Clause] A carbon nanotube sheet comprising: a sheet; and carbon nanotubes whose densities differ in two directions orthogonal to each other in plan view.

What is claimed is:

1. A method of manufacturing a carbon nanotube sheet, comprising:
providing carbon nanotubes;
advancing an elastic sheet having a first surface and a second surface opposite to the first surface in a first direction toward a direction changing member;
bringing the first surface into contact with the direction changing member and looping the elastic sheet over the direction changing member so as to extend the second surface;
advancing the elastic sheet from the direction changing member in a second direction different from the first direction so as to contract the second surface;
causing upper ends of the carbon nanotubes to penetrate the second surface that is extended by being looped over the direction changing member, thereby providing temporal fixation therefor; and
moving the carbon nanotubes in the second direction while the upper ends are penetrating the second surface.

2. The method according to claim 1, further comprising:
after the moving the carbon nanotubes in the second direction,
impregnating gaps between the carbon nanotubes with a resin; and
detaching the carbon nanotubes from the elastic sheet.

3. The method according to claim 2, wherein the impregnating of the gaps between the carbon nanotubes with the resin involves injecting the resin such that a surrounding area of proximal portions of the carbon nanotubes on the elastic sheet becomes a void.

4. The method according to claim 1, wherein the providing the carbon nanotubes includes growing the carbon nanotubes on a substrate.

5. The method according to claim 1, wherein the elastic sheet is a silicone rubber sheet.

6. An apparatus for manufacturing a carbon nanotube sheet, comprising
an unwinding roller from which an elastic sheet having a first surface and a second surface opposite to the first surface is to be unwound;
a winding roller on which the elastic sheet is to be wound;
a direction changing member over which the elastic sheet is to be looped along a path in which the elastic sheet travels between the unwinding roller and the winding roller; and
a stage on which carbon nanotubes are to be placed;
wherein the elastic sheet advances in a first direction from the winding roller to the direction changing member,
the elastic sheet advances in a second direction different from the first direction from the direction changing member to the winding roller, and
the stage having the carbon nanotubes thereon moves in the second direction, the carbon nanotubes being temporarily fixed to the second surface by having upper ends thereof penetrating the second surface that is extended by being looped over the direction changing member.
